(19) United States
(12) Patent Application Publication
(10) Pub. No.: US 2025/0083542 A1
(43) Pub. Date: Mar. 13, 2025

(54) CHARGING DEVICE

(71) Applicant: Lite-On Technology Corporation, Taipei (TW)

(72) Inventor: Li-Yuan Hsu, Taipei (TW)

(73) Assignee: Lite-On Technology Corporation, Taipei (TW)

(21) Appl. No.: 18/585,033

(22) Filed: Feb. 22, 2024

Related U.S. Application Data
(60) Provisional application No. 63/537,207, filed on Sep. 8, 2023.

(30) Foreign Application Priority Data
Jan. 18, 2024 (TW) 113200628

(51) Int. Cl. B60L 53/16; H02J 7/00

(52) U.S. Cl. CPC B60L 53/16; H02J 7/0042

(57) ABSTRACT

A charging device adapted for charging electric vehicles is provided. The charging device includes a charging station, an adapter, and a charging plug. The charging station includes an insertion portion. The adapter has a first side and a second side opposite to each other, the first side is detachably connected to the charging station, and the adapter includes a linkage assembly. The charging plug is detachably connected to the second side of the adapter. In a first state, the charging plug is connected to the second side and the first side is connected to the charging station. In a second state, the charging plug is connected to the second side and the first side is detached from the charging station, and the linkage assembly is engaged to the charging plug, so that the charging plug and the adapter are locked with each other. During a transition from the second state to the first state, the first side of the adapter is connected to the charging station, and the insertion portion pushes the linkage assembly to release a locking relationship between the charging plug and the adapter.

### CROSS-REFERENCE TO RELATED APPLICATION

This application claims the priority benefit of U.S. provisional application Ser. No. 63/537,207, filed on Sep. 8, 2023 and Taiwan application serial no. 113200628, filed on Jan. 18, 2024. The entirety of each of the above-mentioned patent applications is hereby incorporated by reference herein and made a part of this specification.

### BACKGROUND

### Technical Field

The invention relates to a charging device, and particularly relates to a charging device including an adapter.

### Description of Related Art

Along with increasing use of electric carriers (such as electric vehicles), charging devices are becoming more and more popular to meet users' charging needs for the electric vehicles. Generally, a charging device includes a charging station and a charging plug, and a user may charge an electric vehicle by plugging the charging plug into the electric vehicle.

However, types of charging ports of the existing electric vehicles are probably different. One of the goals to be achieved in this field is to design charging devices equipped with adapters to meet usage needs.

### SUMMARY

The invention is directed to a charging device, which is capable of switching an adapter according to usage scenarios, and has good operability and meets safety considerations.

The invention provides a charging device adapted for charging electric vehicles. The charging device includes a charging station, an adapter, and a charging plug. The charging station includes an insertion portion. The adapter has a first side and a second side opposite to each other, the first side is detachably connected to the charging station, and the adapter includes a linkage assembly. The charging plug is detachably connected to the second side of the adapter. In a first state, the charging plug is connected to the second side and the first side is connected to the charging station. In a second state, the charging plug is connected to the second side and the first side is detached from the charging station, and the linkage assembly is engaged to the charging plug, so that the charging plug and the adapter are locked with each other. During a transition from the second state to the first state, the first side of the adapter is connected to the charging station, and the insertion portion pushes the linkage assembly to release a locking relationship between the charging plug and the adapter.

In an embodiment of the invention, the charging plug has a groove, the adapter includes an inner wall, and the linkage assembly includes a protruding portion. The protruding portion movably protrudes from the inner wall. In the second state, the protruding portion corresponds to and is engaged with the groove. The linkage assembly is engaged with the groove of the charging plug through the protruding portion, so that the charging plug and the adapter are locked with each other.

In an embodiment of the invention, the adapter includes a guide groove located on the first side, and the linkage assembly further includes a slide block. The slide block is slidably disposed in the guide groove. During the transition from the second state to the first state, the insertion portion enters the guide groove to push the slide block to move.

In an embodiment of the invention, the adapter further includes a first stopper and an elastic body. The elastic body is located between the first stopper and the slide block. In the first state, the insertion portion presses against the slide block to compress the elastic body.

In an embodiment of the invention, during a transition from the first state to the second state, the insertion portion is detached from the slide block, and the slide block is reset by an elastic force of the elastic body.

In an embodiment of the invention, the linkage assembly further includes a second stopper. The second stopper is located between the protruding portion and the slide block. In the second state, the protruding portion is limited between the second stopper and the groove.

In an embodiment of the invention, during the transition from the second state to the first state, the insertion portion pushes the slide block along a first moving direction to drive the second stopper to move along a second moving direction and depart from the protruding portion. The first moving direction is opposite to the second moving direction.

In an embodiment of the invention, the adapter further includes a first wall located on the first side and a second wall surrounding the first wall, and the guide groove penetrates through the first wall.

In an embodiment of the invention, in the second state, the slide block is aligned with or recessed by a distance from the first wall, and a length of the insertion portion is greater than the distance.

In an embodiment of the invention, in a third state, the charging plug is detached from the adapter and the first side of the adapter is connected to the charging station.

In an embodiment of the invention, during the transition from the first state to the third state, the charging plug pushes the protruding portion, so that the protruding portion moves out of the groove and recesses into the inner wall, and when the charging plug completely moves away from the protruding portion, the protruding portion is reset by an elastic member, and protrudes from the inner wall.

In an embodiment of the invention, the protruding portion is movably located in the groove through an elastic member.

In an embodiment of the invention, the adapter further includes an inner wall and a locking structure. The locking structure includes a pivot portion, a hook and a pressing portion. The pivot portion is pivotably connected to the inner wall. The hook protrudes from the first side, and in the first state, the hook is adapted for engaging with the charging station. The pressing portion and the hook are respectively located on two opposite sides of the pivot portion.

In an embodiment of the invention, during a transition from the first state to the second state, the pressing portion is pressed to unlock an engagement relationship between the hook and the charging station.

In an embodiment of the invention, in the first state, the elastic body is located between the first stopper and the slide block, the first stopper is located between the charging plug and the slide block, and the charging plug presses against the first stopper to compress the elastic body.

In an embodiment of the invention, during the transition from the first state to the third state, the charging plug is detached from the first stopper, and the first stopper moves along a first moving direction by the elastic force of the elastic body to drive at least a part of the first stopper to be located below the pressing portion for limiting a displacement of the pressing portion in a pressing direction, so as to maintain an engagement relationship between the hook and the charging station, so that the adapter and the charging station are locked with each other.

In an embodiment of the invention, the locking structure further includes an elastic portion disposed below the pressing portion for the pressing portion to reset.

In an embodiment of the invention, a charging plug holster of the charging station has a locking slot, and the hook is engaged with the locking slot.

In an embodiment of the invention, the pressing portion is pressed to drive the hook to rotate upward in a rotation direction, and the hook is separated from the locking slot to unlock an engagement relationship between the hook and the charging station.

In an embodiment of the invention, the adapter includes a casing, and the linkage assembly is located in the casing.

Based on the above description, in the charging device of the invention, when a user chooses to use the charging plug with the adapter to charge the electric vehicle, the adapter and the charging plug are locked to avoid unexpected falling off and detachment. When the user uses a simple charging plug to charge the electric vehicle, the adapter and the charging station are locked to avoid unexpected falling off, detachment and theft, so as to maintain good charging performance and comply with safety considerations.

To make the aforementioned more comprehensible, several embodiments accompanied with drawings are described in detail as follows.

### BRIEF DESCRIPTION OF THE DRAWINGS

FIG. 1 is a three-dimensional view of a charging device according to an embodiment of the invention.

FIG. 2 and FIG. 3 are disassembled views of the charging device of FIG. 1 in different states.

FIG. 4A is a perspective view of the charging device of FIG. 1.

FIG. 4B is a side view of the charging device of FIG. 4A.

FIG. 4C is a cross-sectional view of the charging device of FIG. 4A.

FIG. 5 is a schematic diagram of an operation of the charging device of FIG. 2 in another viewing angle.

FIG. 6A and FIG. 6B are schematic diagrams of an operation of the charging device of FIG. 3 in another viewing angle.

### DESCRIPTION OF THE EMBODIMENTS

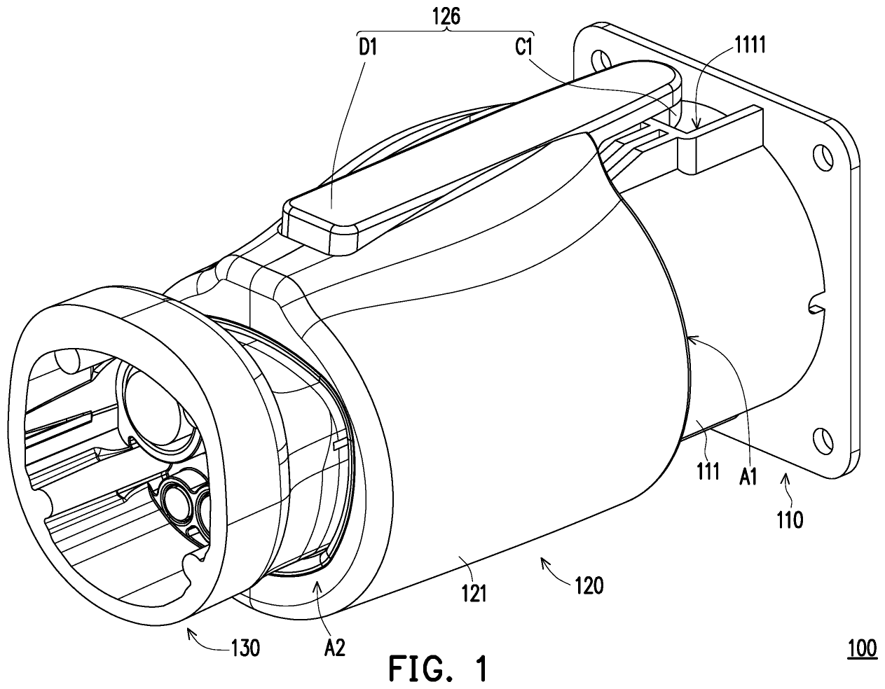

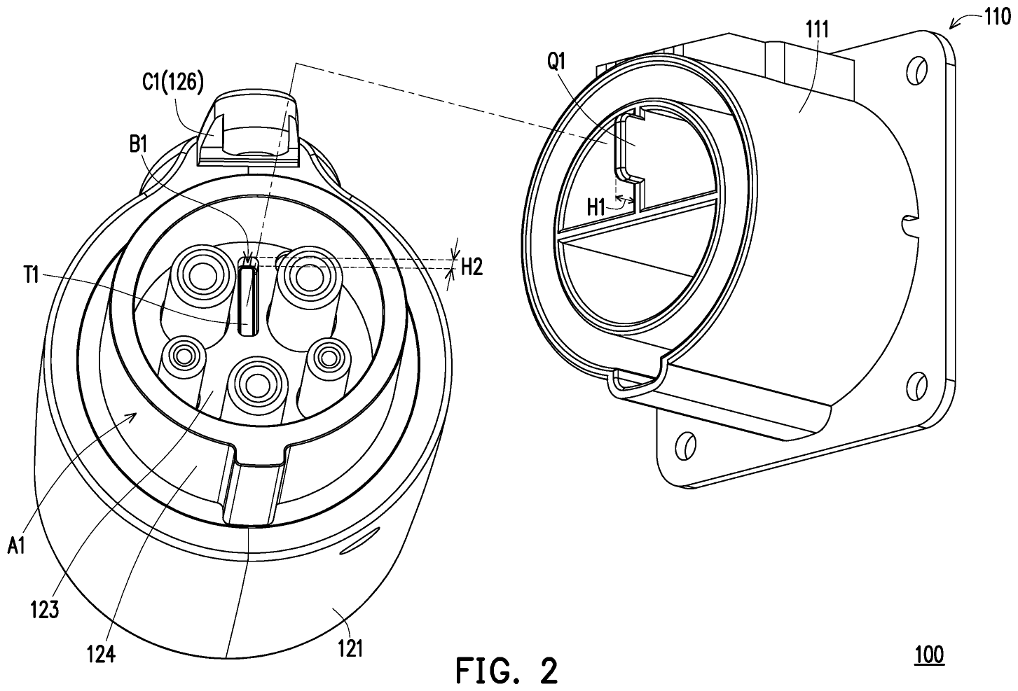

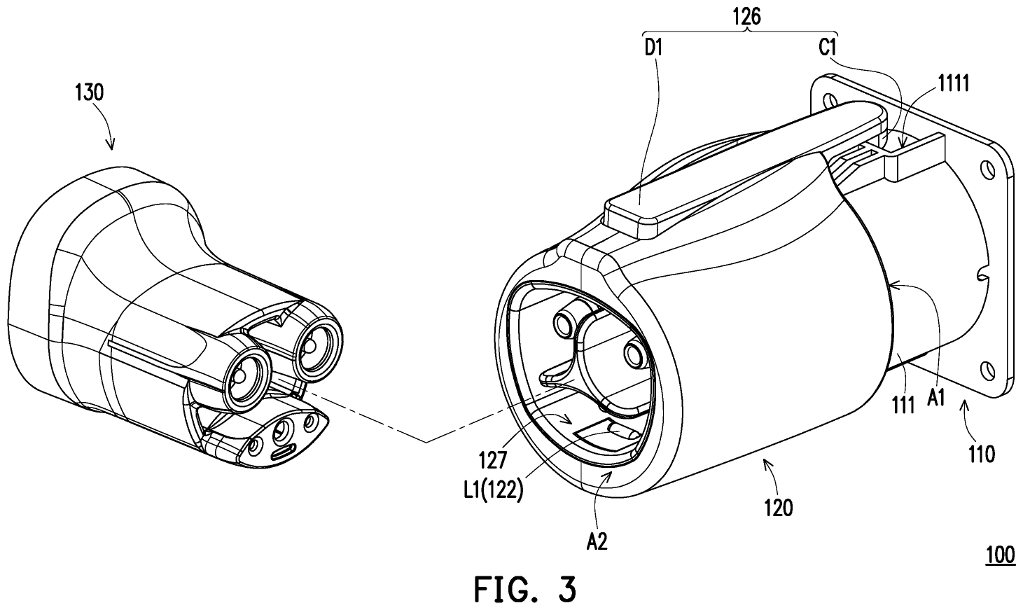

FIG. 1 is a three-dimensional view of a charging device according to an embodiment of the invention. FIG. 2 and FIG. 3 are disassembled views of the charging device of FIG. 1 in different states. Referring to FIG. 1 to FIG. 3, the charging device 100 of the embodiment is adapted for charging electric vehicles. The charging device 100 includes a charging station 110, an adapter 120 and a charging plug 130. The adapter 120 has a first side A1 and a second side A2 opposite to each other. The first side A1 is detachably connected to the charging station 110. The charging plug 130 is detachably connected to the second side A2 of the adapter 120.

In detail, in a first state shown in FIG. 1, the charging plug 130 is connected to the second side A2 and the first side A1 is connected to the charging station 110.

In a second state shown in FIG. 2, the first side A1 of the adapter 120 is detached from the charging station 110. A user may charge an electric vehicle through a connector on the first side A1. The connector on the first side A1 is, for example, of a J1772 specification, but the invention is not limited thereto. During a charging process, the charging plug 130 is locked on the second side A2 of the adapter 120 to avoid unexpected falling off and detachment, thereby maintaining good charging performance and complying with safety considerations.

In a third state shown in FIG. 3, the charging plug 130 is detached from the adapter 120 and the first side A1 of the adapter 120 is connected to the charging station 110. The user may charge the electric vehicle through a connector of the charging plug 130. The connector of the charging plug 130 is, for example, of a TPC specification, but the invention is not limited thereto. During the charging process, the adapter 120 is locked on the charging station 110 to avoid unexpected falling off and detachment, thereby achieving an anti-theft effect.

A mechanism of switching the adapter is further described below.

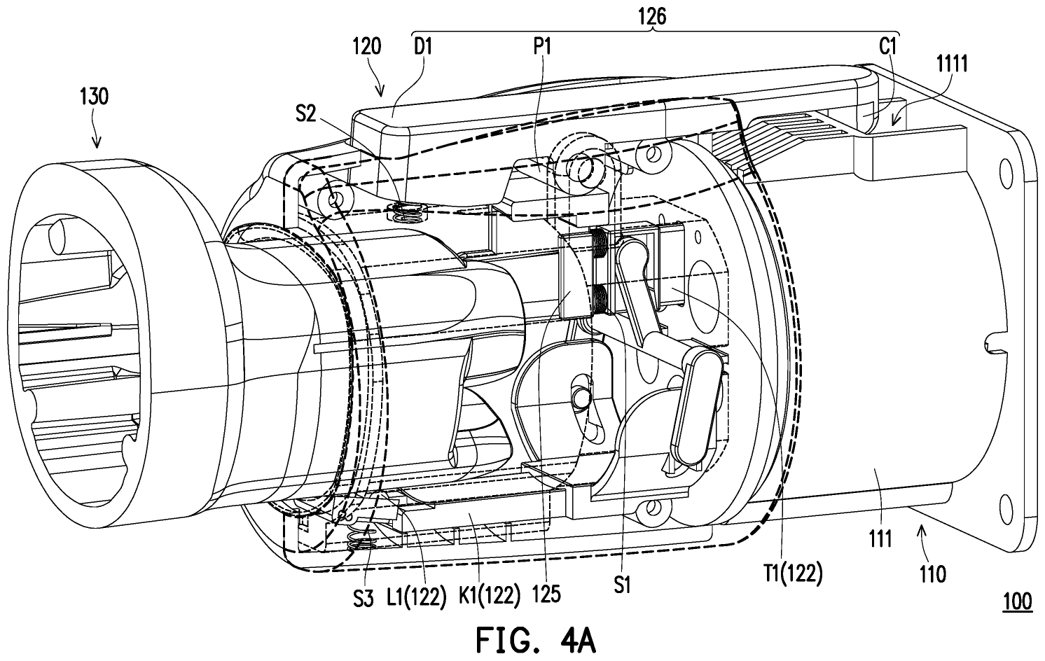

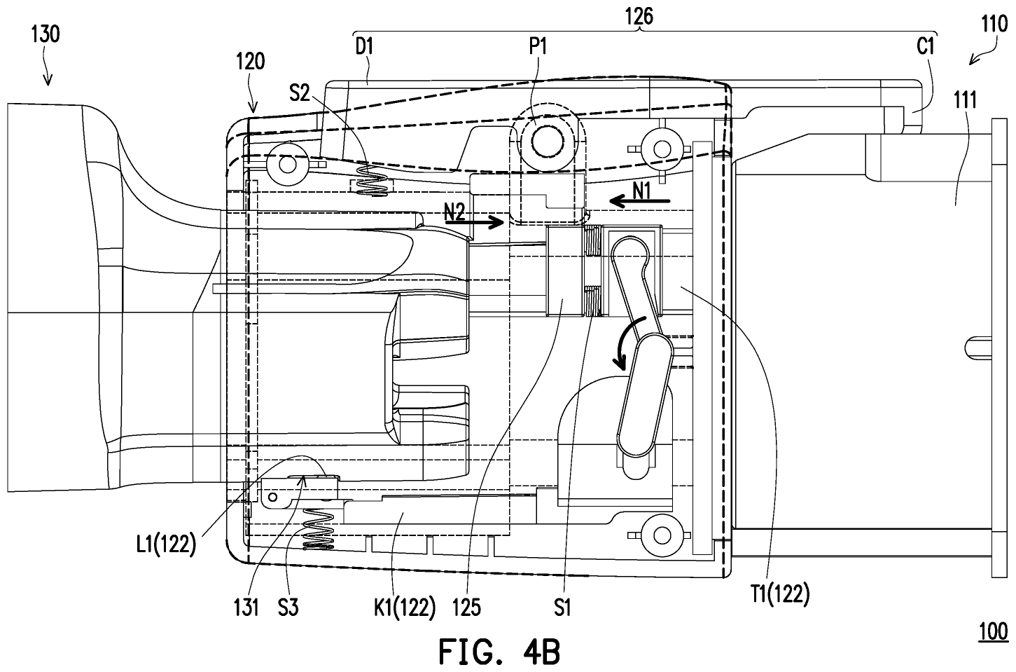

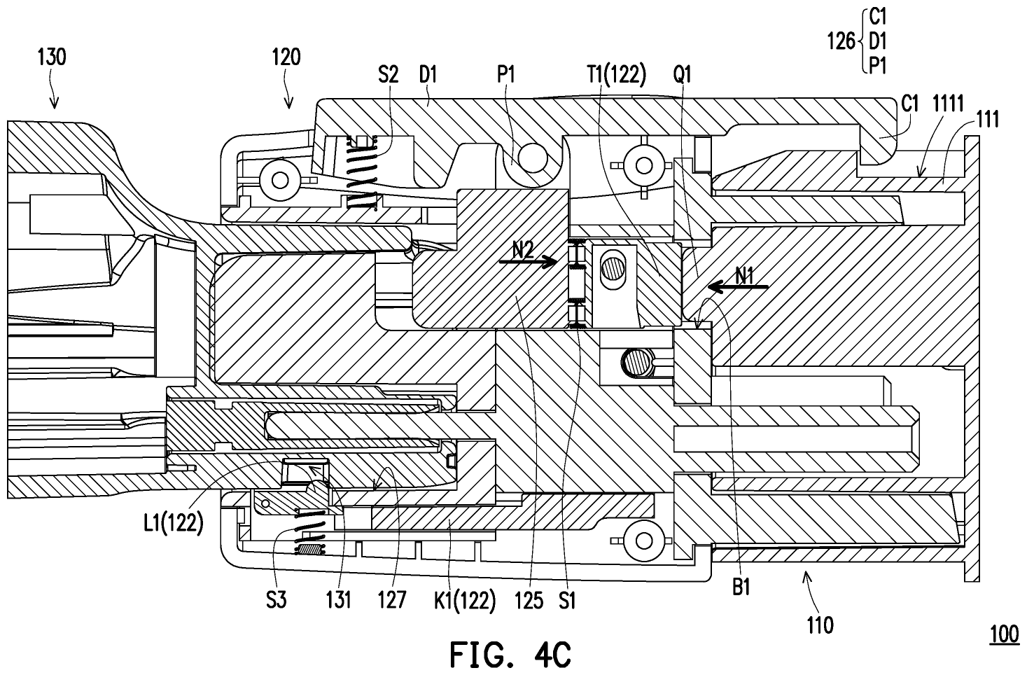

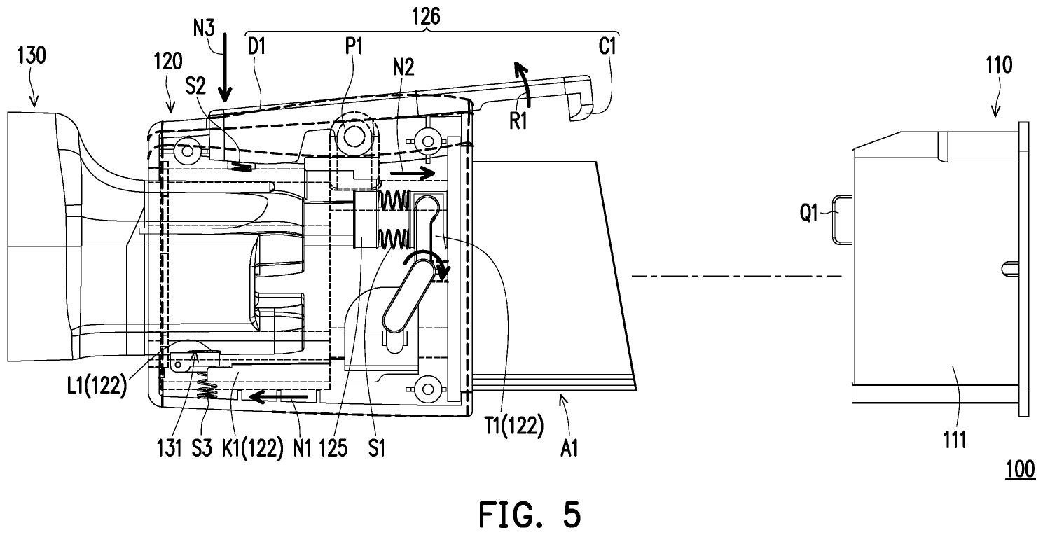

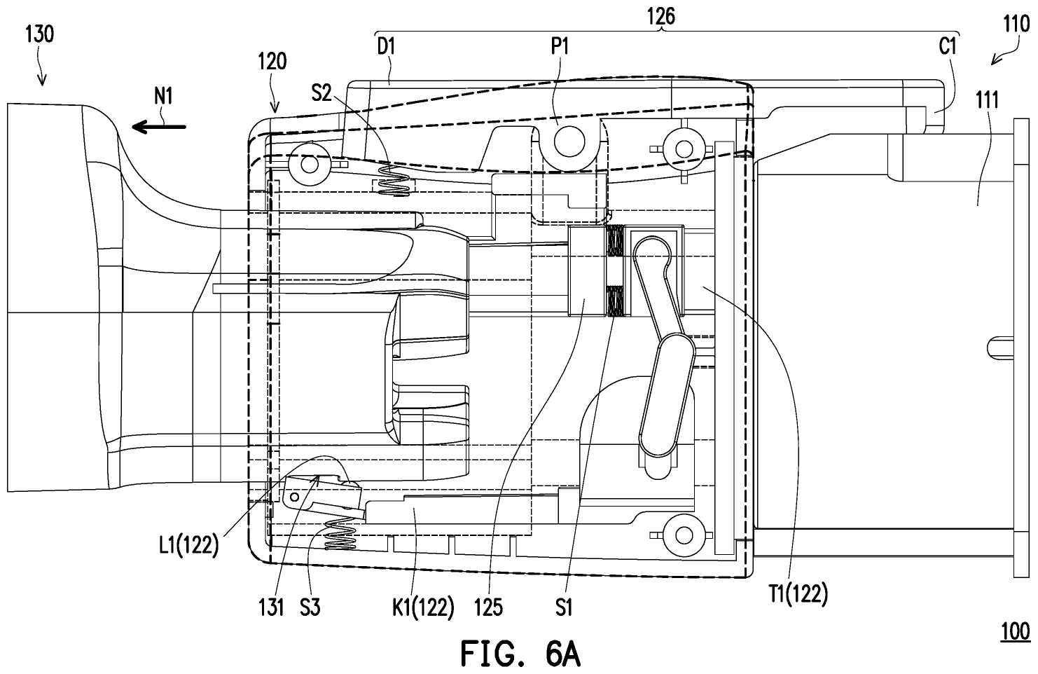

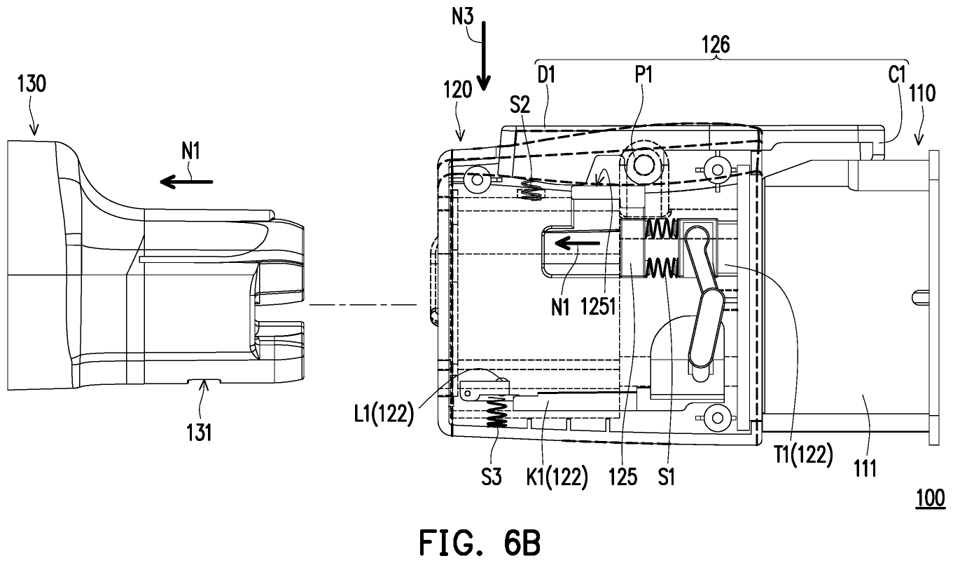

FIG. 4A is a perspective view of the charging device of FIG. 1. FIG. 4B is a side view of the charging device of FIG. 4A. FIG. 4C is a cross-sectional view of the charging device of FIG. 4A. FIG. 5 is a schematic diagram of an operation of the charging device of FIG. 2 in another viewing angle. FIG. 6A and FIG. 6B are schematic diagrams of an operation of the charging device of FIG. 3 in another viewing angle. It should be noted that FIG. 4A, FIG. 4B, FIG. 5, FIG. 6A and FIG. 6B illustrate the adapter 120 in a partial perspective manner to clearly illustrate its internal structures.

Referring to FIG. 2 first, in the embodiment, the charging station 110 includes an insertion portion Q1. The adapter 120 includes a guide groove B1 located on the first side A1.

Referring to FIG. 4A, FIG. 4B and FIG. 4C, in the embodiment, the adapter 120 includes a linkage assembly 122, an inner wall 127, a casing 121 (see FIG. 2) and a locking structure 126. The charging plug 130 has a groove 131.

In the embodiment, the linkage assembly 122 includes a slide block T1, a protruding portion L1 and a second stopper K1. The slide block T1 slidably disposed in the guide groove B1. The protruding portion L1 movably protrudes from the inner wall 127. The second stopper K1 is located between the protruding portion L1 and the slide block T1. It should be noted that the linkage assembly 122 may also include a plurality of rods, and connections of the multiple rods may be designed according to actual needs to achieve an effect of interfering with the protruding portion L1, which is not limited by the invention. In the embodiment, the linkage assembly 122 is located in the casing 121 (referring to FIG. 2), but the invention is not limited thereto.

In the embodiment, the adapter 120 further includes a first stopper 125 and an elastic body S1. The elastic body S1 is located between the first stopper 125 and the slide block T1. The locking structure 126 includes a pivot portion P1, a hook C1 and a pressing portion D1. The pivot portion P1 is pivotably connected to the inner wall 127. The hook C1 protrudes from the first side A1 (referring to FIG. 3). The pressing portion D1 and the hook C1 are respectively located on two opposite sides of the pivot portion P1. An elastic portion S2 is disposed below the pressing portion D1 to allow the pressing part D1 to reset, but the invention is not limited thereto. The elastic portion S2 is, for example, a spring, but the invention is not limited thereto.

In the first state shown in FIG. 1, FIG. 4A, FIG. 4B and FIG. 4C, the hook C1 is engaged with a charging plug holster 111 of the charging station 110. For example, the charging plug holster 111 has a locking slot 1111, and the hook C1 is engaged with the locking slot 1111, but the invention is not limited thereto.

More specifically, the protruding portion L1 is movably located in the groove 131 through an elastic member S3. The elastic member S3 is, for example, a spring, but the invention is not limited thereto. The first stopper 125 is located between the charging plug 130 and the slide block T1. The insertion portion Q1 presses against the slide block T1 along a first moving direction N1 to compress the elastic body S1. The charging plug 130 presses against the first stopper 125 along a second moving direction N2 to compress the elastic body S1, where the first moving direction N1 is opposite to the second moving direction N2. The elastic body S1 is, for example, a spring, but the invention is not limited thereto. At least a part of the first stopper 125 is exposed from the adapter 120 for the charging plug 130 to press, but the invention is not limited thereto. Moreover, in an embodiment, the at least a part of the first stopper 125 exposed from the adapter 120 has a retaining wall (not shown) around it to prevent an unexpected external force from contacting the first stopper 125, but the invention is not limited thereto.

In a process of transition from the first state shown in FIG. 1 to the second state shown in FIG. 2, referring to FIG. 5, the pressing portion D1 is pressed to drive the hook C1 to rotate upward along a rotation direction R1, and the hook C1 is separated from the locking slot 1111 to unlock an engagement relationship between the hook C1 and the charging station 110. Furthermore, the insertion portion Q1 is detached from the slide block T1, and the slide block T1 is reset along the second moving direction N2 by an elastic force of the elastic body S1 (referring to FIG. 4C for details).

Furthermore, the reset of the slide block T1 may drive the second stopper K1 to move along the first moving direction N1, so that at least a part of the second stopper K1 moves to the underneath of the protruding portion L1. The protruding portion L1 corresponds to and engages with the groove 131, i.e., the protruding portion L1 is limited between the second stopper K1 and the groove 131. In this way, in the second state shown in FIG. 2 and FIG. 5, the linkage assembly 122 is engaged with the groove 131 of the charging plug 130 through the protruding portion L1, so that the charging plug 130 and the adapter 120 are locked with each other.

In the process of transition from the second state shown in FIGS. 2 and 5 to the first state shown in FIG. 4A, FIG. 4B and FIG. 4C, the insertion portion Q1 pushes the linkage assembly 122 to release the locking relationship between the charging plug 130 and the adapter 120. Specifically, the insertion portion Q1 enters the guide groove BI along the first moving direction N1, and pushes the slide block T1 to drive the second stopper K1 to move along the second moving direction N2 and depart from the protruding portion L1, so that the protruding portion L1 may be in a free state and may be displaced due to force.

During the transition from the first state shown in FIG. 1 to the third state shown in FIG. 3, referring to FIG. 6A and FIG. 6B, the charging plug 130 moves along the first moving direction N1 and pushes the protruding portion L1, so that the protruding portion L1 is moved out of the groove 131 and recessed into the inner wall 127, and when the charging plug 130 is completely moved away from the protruding portion L1, the protruding portion L1 is reset by the elastic member S3 and protrudes from the inner wall 127. Since the charging plug 130 is detached from the first stopper 125, the first stopper 125 moves along the first moving direction N1 by the elastic force of the elastic body S1 and a top surface 1251 of at least a part of the first stopper 125 is located below the pressing portion D1. In this way, in the third state shown in FIG. 6B, the first stopper 125 is used to limit displacement of the pressing portion D1 in a pressing direction N3 to maintain the engagement relationship between the hook C1 and the charging station 110, so that the adapter 120 and the charging station 110 are locked with each other. The pressing direction N3 is perpendicular to the first moving direction N1.

Under the above configuration, when the charging plug 130 is placed on the charging station 110, the user may freely select a plug head type and retrieve it easily. When the user takes the charging plug 130 with the adapter 120 out of the charging station 110, the adapter 120 and the charging plug 130 are locked, even if they are plugged into the electric vehicle. On the other hand, if the user chooses to use the charging plug 130 without the adapter 120, the adapter 120 is fixedly placed on the charging station 110, and the adapter 120 is locked on the charging station 110 to prevent others from arbitrarily taking the adapter 120 to achieve an anti-theft effect.

Furthermore, in the embodiment, since pin definitions of the J1772 specification and the TPC specification match each other, and the pins do not cross, configuration of the linkage assembly 122 will not affect the related structure of the pins, which maintains a good electrical connection.

Referring to FIG. 2, in the embodiment, the adapter 120 further includes a first wall 123 located on the first side A1 and a second wall 124 surrounding the first wall 123, and the second wall 124 may prevent an unexpected external force from touching the slide block T1, but the invention is not limited thereto.

In the embodiment, the guide groove B1 penetrates through the first wall 123 in an installation direction, and in the second state shown in FIG. 2, the slide block T1 is recessed by a distance H2, and a length H1 of the insertion portion Q1 in the installation direction is greater than the distance H2, but the invention is not limited thereto. In another embodiment, the slide block T1 is aligned with the first wall 123, and as long as the insertion portion Q1 may push the slide block T1 in the guide groove B1 to generate sufficient displacement, it is considered to be within a protection scope of the invention.

In addition, in the embodiment, the charging device 100 has good waterproof performance, and joints may be protected through glue potting and waterproof rubber, but the waterproof method is not limited thereto.

In summary, in the charging device of the invention, when a user chooses to use the charging plug with the adapter to charge the electric vehicle, the adapter and the charging plug are locked to avoid unexpected falling off and detachment, so as to maintain good charging performance and meet safety requirements. When the user chooses to use the charging plug that does not require the adapter, the adapter is fixedly placed on the charging station, and the adapter is locked on the charging station, which may prevent unexpected falling off and detachment to achieve an anti-theft effect.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A charging device, adapted for charging electric vehicles, comprising:
a charging station, comprising an insertion portion;
an adapter, having a first side and a second side opposite to each other, wherein the first side is detachably connected to the charging station, and the adapter comprises a linkage assembly; and
a charging plug, detachably connected to the second side of the adapter, wherein
in a first state, the charging plug is connected to the second side and the first side is connected to the charging station,
in a second state, the charging plug is connected to the second side and the first side is detached from the charging station, and the linkage assembly is engaged to the charging plug, so that the charging plug and the adapter are locked with each other,
during a transition from the second state to the first state, the first side of the adapter is connected to the charging station, and the insertion portion pushes the linkage assembly to release a locking relationship between the charging plug and the adapter.

2. The charging device as claimed in claim 1, wherein the charging plug has a groove, the adapter comprises an inner wall, and the linkage assembly comprises:
a protruding portion, movably protruding from the inner wall, wherein
in the second state, the protruding portion corresponds to and is engaged with the groove, the linkage assembly is engaged with the groove of the charging plug through the protruding portion, so that the charging plug and the adapter are locked with each other.

3. The charging device as claimed in claim 2, wherein the adapter comprises a guide groove located on the first side, and the linkage assembly further comprises:
a slide block, slidably disposed in the guide groove, wherein
during the transition from the second state to the first state, the insertion portion enters the guide groove to push the slide block to move.

4. The charging device as claimed in claim 3, wherein the adapter further comprises a first stopper and an elastic body, the elastic body is located between the first stopper and the slide block, and in the first state, the insertion portion presses against the slide block to compress the elastic body.

5. The charging device as claimed in claim 4, wherein during a transition from the first state to the second state, the insertion portion is detached from the slide block, and the slide block is reset by an elastic force of the elastic body.

6. The charging device as claimed in claim 4, wherein the linkage assembly further comprises:
a second stopper, located between the protruding portion and the slide block, wherein
in the second state, the protruding portion is limited between the second stopper and the groove.

7. The charging device as claimed in claim 6, wherein during the transition from the second state to the first state, the insertion portion pushes the slide block along a first moving direction to drive the second stopper to move along a second moving direction and depart from the protruding portion, and the first moving direction is opposite to the second moving direction.

8. The charging device as claimed in claim 3, wherein the adapter further comprises a first wall located on the first side and a second wall surrounding the first wall, and the guide groove penetrates through the first wall.

9. The charging device as claimed in claim 8, wherein in the second state, the slide block is aligned with or recessed by a distance from the first wall, and a length of the insertion portion is greater than the distance.

10. The charging device as claimed in claim 2, wherein in a third state, the charging plug is detached from the adapter and the first side of the adapter is connected to the charging station.

11. The charging device as claimed in claim 10, wherein during a transition from the first state to the third state, the charging plug pushes the protruding portion, so that the protruding portion moves out of the groove and recesses into the inner wall, and when the charging plug completely moves away from the protruding portion, the protruding portion is reset by an elastic member, and protrudes from the inner wall.

12. The charging device as claimed in claim 2, wherein the protruding portion is movably located in the groove through an elastic member.

13. The charging device as claimed in claim 1, wherein in a third state, the charging plug is detached from the adapter and the first side of the adapter is connected to the charging station.

14. The charging device as claimed in claim 13, wherein the adapter further comprises an inner wall and a locking structure, and the locking structure comprises:
a pivot portion, pivotably connected to the inner wall;
a hook, protruding from the first side, wherein in the first state, the hook is adapted for engaging with the charging station; and
a pressing portion, wherein the pressing portion and the hook are respectively located on two opposite sides of the pivot portion.

15. The charging device as claimed in claim 14, wherein during a transition from the first state to the second state, the pressing portion is pressed to unlock an engagement relationship between the hook and the charging station.

16. The charging device as claimed in claim 14, wherein the adapter comprises a guide groove located on the first side, and the linkage assembly further comprises:
a slide block, slidably disposed in the guide groove.

17. The charging device as claimed in claim 16, wherein the adapter further comprises a first stopper and an elastic body, in the first state, the elastic body is located between the first stopper and the slide block, the first stopper is located between the charging plug and the slide block, and the charging plug presses against the first stopper to compress the elastic body.

18. The charging device as claimed in claim 17, wherein during the transition from the first state to the third state, the charging plug is detached from the first stopper, and the first stopper moves along a first moving direction by an elastic force of the elastic body to drive at least a part of the first stopper to be located below the pressing portion for limiting a displacement of the pressing portion in a pressing direction, so as to maintain an engagement relationship between the hook and the charging station, so that the adapter and the charging station are locked with each other.

19. The charging device as claimed in claim 14, wherein the locking structure further comprises an elastic portion disposed below the pressing portion for the pressing portion to reset.

20. The charging device as claimed in claim 14, wherein a charging plug holster of the charging station has a locking slot, and the hook is engaged with the locking slot.

21. The charging device as claimed in claim 20, wherein the pressing portion is pressed to drive the hook to rotate upward in a rotation direction, and the hook is separated from the locking slot to unlock an engagement relationship between the hook and the charging station.

22. The charging device as claimed in claim 1, wherein the adapter comprises a casing, and the linkage assembly is located in the casing.
